(19) United States
(12) Patent Application Publication
(10) Pub. No.: US 2007/0123634 A1
(43) Pub. Date: May 31, 2007

(54) Process for making a flame retardant polycarbonate composition

(75) Inventors: James Y.J. Chung, Wexford, PA (US); Winfried G. Paul, Pittsburgh, PA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 11/640,692

(22) Filed: Dec. 18, 2006

Related U.S. Application Data
(63) Continuation-in-part of application No. 10/999,697, filed on Nov. 30, 2004, now abandoned.

(30) Foreign Application Priority Data
Nov. 22, 2005 (US) PCT/US05/42506
Nov. 29, 2005 (TW) 94141797

(51) Int. Cl. C09B 67/00

(52) U.S. Cl. 524/502

(57) ABSTRACT

A process of the preparation of a flame-retardant thermoplastic molding composition is disclosed. The process entails adding an aqueous dispersion of PTFE into stationary polycarbonate resin in the form pellets and/or powder to obtain a material system, and blending the resulting material system, drying it and melt blending the dried mixture to obtain a molding composition. The composition exhibits good surface appearance, and high impact strength as well as stringent flammability rating even without the incorporation of additional flame retardant agent therewith.

This Application is a Continuation-In-Part of Application number 10/999,697 filed Nov. 30, 2004.

### FIELD OF THE INVENTION

The invention concerns a thermoplastic molding composition and in particular a flame retardant polycarbonate composition and a process for its preparation.

### BACKGROUND OF THE INVENTION

Thermoplastic, flame-retardant molding compositions that contain polycarbonate resin are known. The introduction of salts to polycarbonate to achieve improved flame retardance, notably UL94-V0 rating at ⅛″ and/or UL94-V0 at 1/16″, has been disclosed in U.S. Pat. Nos. 3,535,300; 3,775,367; 3,909,490; and 3,917,559.

Also known are polycarbonate compositions that attain more rigorous flammability standards (i.e., UL94-5VA at ⅛″ and/or UL94-V0 at 1/16″) by the incorporation of conventional flame retarding agents and polytetrafluoroethylene (PTFE) as a drip suppressant. German Patent 2,535,262 and U.S. Pat. Nos. 4,223,100 and 4,626,563 disclosed adding PTFE to a polycarbonate containing the flame retardant salts to retard dripping. Fibrillating PTFE used as an anti-dripping agent for flame-retardant polycarbonate composition is known to cause surface defects (pitting, silver streaking, and splay) in the molded part.

Efforts addressing the problem of surface defects were reported in U.S. Pat. No. 4,649,168 that disclosed alkali metal salts with intimate mixtures of PTFE/ABS (acrylonitrile, butadiene and styrene graft copolymer), which were prepared by co-coagulating PTFE emulsion together with ABS emulsion. U.S. Pat. No. 4,753,994 disclosed co-precipitated, coagulate of PTFE in polycarbonate prepared from a polycarbonate solution in a halogenated hydrocarbon and an aqueous dispersion of the fluoropolymer. The resulting co-precipitate was then added as a component in the preparation of flame retardant polycarbonate molding compositions. U.S. Pat. No. 4,772,655 disclosed the use of fumed silica in combination with PTFE and flame retardant salts. U.S. Pat. No. 5,804,654 disclosed using encapsulated PTFE/SAN powder prepared by co-coagulating emulsion blends of PTFE dispersion and SAN (styrene and acrylonitrile copolymer) emulsion, in combination with a flame retardant synergist. U.S. Pat. No. 6,180,702 disclosed flame retardant polycarbonate compositions that contain a flame retardant salt and physical mixture of PTFE and poly(alkyl methacrylate) prepared by co-coagulating PTFE dispersion and poly(alkyl methacrylate) emulsion.

U.S. Pat. No. 5,102,696 disclosed a method for dispersing fluoropolymers in polycarbonate resins. Accordingly an aqueous PTFE dispersion is added to a predetermined situs of the solid polycarbonate particles at a specified rate to prepare a PTFE concentrate, the resulting composition features reduced splay. The flame retardance of the referenced compositions and of the comparable composition prepared by pouring or “dumping” of the dispersion has been reported to yield V-0 at 1/16″ upon the inclusion of a flame retardant salt and a brominated flame retardant.

U.S. Pat. Nos. 5,102,696, 5,773,493 and 6,005,025 disclosed dispersing solid additives into polymers and products made therewith. The methods involve adding aqueous PTFE dispersion to a solution of polymer in a tubular mixer. The mixer leads to a steam precipitation step wherein all fluid ingredients in the mixture are volatilized.

U.S. Pat. No. 6,040,370 disclosed aqueous PTFE dispersion and method making fluoropolymer-containing thermoplastic resin composition. A fluoropolymer additive is made by aqueous emulsion polymerization of one or more ethylenically unsaturated monomers in the presence of the stabilized fluoropolymer dispersion or in the alternative, by co-coagulation of the stabilized fluoropolymer dispersion and an aqueous emulsion of a second polymer. A fluoropolymer-containing thermoplastic resin composition is made by combining the fluoropolymer additive with a thermoplastic resin.

In all the aforementioned publications, attaining flame retardance ratings of UL94-5VA at ⅛″ and/or UL94-V0 at 1/16″ for aromatic polycarbonate molding compositions that contain PTFE requires the inclusion of an additional flame retardant additive, such as a sulfonate salt and/or a brominated compound.

EP 0 900 641 disclosed a process for the preparation of a polymer composition that contains PTFE emulsion. Accordingly a mixture containing polycarbonate powder and powdered functional additives was obtained by mixing the components at room temperature with the aid of a high speed mixing apparatus and subsequently mixing the powdered mixture with PTFE emulsion in an extruder at 280° C. The PTFE emulsion was fed to the extruder's hopper by means of a peristatic pump. The set flow rate was 1.44 g/minute (drop by drop). A comparative example entailing an identical composition was prepared by mixing the components in an extruder. The PTFE component was added by first preparing a pre-mix before the extrusion. The premix was prepared by mixing polycarbonate powder, PTFE emulsion and powdered additives at room temperature using a high speed mixing apparatus. The resulting sticky powder was fed to the hopper of an extruder and mixed at 280° C. Reportedly, it was difficult to dose the premix properly and regularly because the premix regularly adhered to the hopper because of its stickiness.

### SUMMARY OF THE INVENTION

A process of the preparation of a flame-retardant thermoplastic molding composition is disclosed. The process entails adding an aqueous dispersion of PTFE into stationary polycarbonate resin in the form pellets and/or powder to obtain a material system, and blending the resulting material system, drying it and melt blending the dried mixture to obtain a molding composition. The composition exhibits good surface appearance, and high impact strength as well as stringent flammability rating even without the incorporation of additional flame retardant agent therewith.

### DETAILED DESCRIPTION OF THE INVENTION

The invention resides in the finding that a flame retardant polycarbonate composition may be prepared by introducing PTFE in the form of an aqueous dispersion into stationary polycarbonate in the form of powder and/or pellets. The inventive composition is characterized by its excellent flame retardance (UL94-V0 at 1/16″ and/or UL94-5VA at ⅛″) attained in the absence of other flame retarding agents, good part appearance and high impact strength (notched Izod) of at least 10 ft-lb/in at ⅛″ thickness.

The inventive process includes (i) introducing an aqueous dispersion of PTFE into stationary aromatic polycarbonate resin in the form of powder and/or pellets to obtain a material system and then (ii) blending the system, optionally with additional polycarbonate, to obtain a mixture and (iii) drying the mixture under conditions to render the mixture to screw-feed into an extruder, preferably drying to obtain a dried mixture having water content less than 2, preferably less than 1.5% percent relative to its weight, and (iv) melt blending the dried mixture, optionally with additional polycarbonate, to obtain the inventive thermoplastic composition. The resulting composition contains PTFE in an amount sufficient to impart to the composition the above mentioned properties without the incorporation of additional flame retardant agent therewith. Advantageously, the amount of dispersion introduced is 0.2 to 25, more preferably 0.30 to 15, percent relative to the weight of the material system. The amount of PTFE in the inventive composition is preferably 0.2 to 1.0 percent relative to the weight of the composition.

As used in this text, the term “stationary” refers to the state of polycarbonate component, and means that the resin is motionless and not agitated in the course of introduction of the aqueous PTFE dispersion.

Polycarbonates within the scope of the present invention are homopolycarbonates, copolycarbonates, branched polycarbonate and mixtures thereof. The polycarbonates generally have a weight average molecular weight of 10,000 to 200,000, preferably 20,000 to 80,000 and their melt flow rate, per ASTM D-1238 at 300° C., is about 1 to about 85 g/10 min., preferably about 2 to 30 g/10 min. They may be prepared, for example, by the known diphasic interface process from a carbonic acid derivative such as phosgene and dihydroxy compounds by polycondensation (see German Offenlegungsschriften 2,063,050; 2,063,052; 1,570,703; 2,211,956; 2,211,957 and 2,248,817; French Patent 1,561,518; and the monograph H. Schnell, “Chemistry and Physics of Polycarbonates”, Interscience Publishers, New York, N.Y., 1964, all incorporated herein by reference).

In the present context, dihydroxy compounds suitable for the preparation of the polycarbonates of the invention conform to the structural formulae (1) or (2) 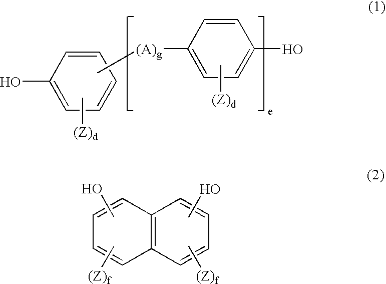
wherein
A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂— or a radical conforming to 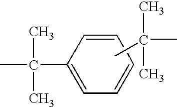
e and g both denote the number 0 to 1; Z denotes F, Cl, Br or C₁-C₄-alkyl and if several Z radicals are substituents in one aryl radical, they may be identical or different from one another; d denotes an integer of from 0 to 4; and f denotes an integer of from 0 to 3.

Among the dihydroxy compounds useful in the practice of the invention are hydroquinone, resorcinol, bis-(hydroxyphenyl)-alkanes, bis-(hydroxyphenyl)-ethers, bis-(hydroxyphenyl)-ketones, bis-(hydroxyphenyl)-sulfoxides, bis-(hydroxyphenyl)-sulfides, bis-(hydroxyphenyl)-sulfones, 2,2,4-trimethylcyclohexyl-1,1-diphenol and α,α-bis-(hydroxyphenyl)-diisopropylbenzenes, as well as their nuclear-alkylated compounds. These and further suitable aromatic dihydroxy compounds are described, for example, in U.S. Pat. Nos. 3,028,356; 2,999,835; 3,148,172; 2,991,273; 3,271,367; and 2,999,846, all incorporated herein by reference.

Further examples of suitable bisphenols are 2,2-bis-(4-hydroxyphenyl)-propane (bisphenol A), 2,4-bis-(4-hydroxyphenyl)-2-methylbutane, 1,1-bis-(4-hydroxyphenyl)-cyclohexane, α,α′-bis-(4-hydroxyphenyl)-p-diisopropylbenzene, 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxyphenyl)-sulfoxide, bis-(3,5-dimethyl-4-hydroxyphenyl)-sulfone, dihydroxybenzophenone, 2,4-bis-(3,5-dimethyl-4-hydroxyphenyl)-cyclohexane, α,α′-bis-(3,5-dimethyl-4-hydroxyphenyl)-p-diisopropylbenzene, 2,2,4-trimethyl cyclohexyl-1,1-diphenol and 4,4′-sulfonyl diphenol.

Examples of particularly preferred aromatic bisphenols are 2,2,-bis-(4-hydroxyphenyl)-propane, 2,2-bis-(3,5-dimethyl-4-hydroxyphenyl)-propane, 2,2,4-trimethyl cyclohexyl-1,1-diphenol and 1,1-bis-(4-hydroxyphenyl)-cyclohexane.

The most preferred bisphenol is 2,2-bis-(4-hydroxyphenyl)-propane (bisphenol A).

The polycarbonates of the invention may entail in their structure units derived from one or more of the suitable bisphenols.

Among the resins suitable in the practice of the invention are included phenolphthalein-based polycarbonates, copolycarbonates and terpolycarbonates such as are described in U.S. Pat. Nos. 3,036,036 and 4,210,741, both incorporated by reference herein.

The polycarbonates of the invention may also be branched by condensing therein small quantities, e.g., 0.05 to 2.0 mol % (relative to the bisphenols) of polyhydroxyl compounds.

Polycarbonates of this type have been described, for example, in German Offenlegungsschriften 1,570,533; 2,116,974 and 2,113,374; British Patents 885,442 and 1,079,821 and U.S. Pat. No. 3,544,514. The following are some examples of polyhydroxyl compounds which may be used for this purpose: phloroglucinol; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxyphenyl)-2-(2,4-dihydroxy-phenyl)-propane and 1,4-bis-(4,4′-dihydroxy-triphenylmethyl)-benzene. Some of the other polyfunctional compounds are 2,4-dihydroxybenzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in the incorporated herein by reference U.S. Pat. Nos. 3,028,365; 2,999,846; 3,153,008; and 2,991,273.

The preferred process for the preparation of polycarbonates is the interfacial polycondensation process.

Other methods of synthesis in forming the polycarbonates of the invention such as disclosed in U.S. Pat. No. 3,912,688, incorporated herein by reference, may be used.

Suitable polycarbonate resins are available in commerce, for instance, Makrolon CD 2005, Makrolon FCR 2400, Makrolon 2600, Makrolon 2800 and Makrolon 3200, all of which are bisphenol based homopolycarbonate resins differing in terms of their respective molecular weights and characterized in that their melt flow indices (MFR) per ASTM D-1238 are about 60 to 85, 16.5 to 24,13 to 16, 7.5 to 13.0 and 3.5 to 6.5 g/10 min., respectively. A branched polycarbonate such as Makrolon 1239 can also be used. These are products of Bayer MaterialScience LLC, of Pittsburgh, Pa.

A polycarbonate resin suitable in the practice of the invention is known and its structure and methods of preparation have been disclosed, for example in U.S. Pat. Nos. 3,030,331; 3,169,121; 3,395,119; 3,729,447; 4,255,556; 4,260,731; 4,369,303 and 4,714,746 all of which are incorporated by reference herein.

The polycarbonate to be used in the inventive process is in the form of pellets and/or powder. These forms are known and polycarbonate compositions confirming to these forms are available commercially and/or may be prepared by conventional means.

Aqueous dispersions of PTFE suitable in the context of the invention are known and are commercially available from Dyneon LLC under the designations PA 5958 and PA 5959. In accordance with their Material Safety Data Sheet, the Dyneon products contain 50-60% of PTFE, 35-50% of water, 0.5 to 6% of alkylphenolethoxylate, and <0.5% of ammonium perfluorooctanoate. The average particle size (diameter) of the preferred dispersed particles is about 0.05 to 0.5 microns.

The amount of PTFE which is incorporated into the polycarbonate resin in the context of the present invention is the amount that is sufficient, without the inclusion of additional flame retarding agents, to render the blend of polycarbonate and PTFE flammability rating of UL94-5VA at ⅛″ and/or UL94-V0 at 1/16″ in accordance with UL-94 test. In a preferred embodiment the amount of PTFE in the composition is about 0.2 to 1.0 percent relative to the weight of the composition, more particularly 0.30 to 0.60 percent.

The introduction of PTFE to the stationary polycarbonate in accordance with the inventive process may be carried out by conventional means such as by introducing these components at an ambient temperature, and after introduction employing conventional mixing equipment such as mixing rolls, dough mixers, tumble blenders, Banbury mixers and the like. The rate at which the two components are brought in contact with each other is not critical to the process of the invention and include metering at measured predetermined rates, “dumping” of the fluoropolymer into the polycarbonate and spraying of the fluoropolymer onto a bed of the stationary polycarbonate particles. The resulting mixture is then dried at temperature ranging from room temperature to 120° C., preferably 25 to 80° C., resulting in a dried mixture in which water content is less than 2 percent by weight, preferably less than 1.5 percent by weight, to enable it to be screw-fed into an extruder and the dried mixture then melt blended, optionally together with additional polycarbonate to obtain the thermoplastic molding composition.

The composition of the present invention may contain various conventional additives, such as: antioxidants, UV absorbers, light absorbers, metal deactivators, fillers and reinforcing agents, lubricants, plasticizers, optical brighteners, pigments, dyes, colorants, flame proofing agents; anti-static agents and blowing agents.

Suitable antioxidants include organophosphites, e.g., tris(nonylphenyl)phosphite, (2,4,6-tri-tert-butylphenyl)(2-butyl-2-ethyl-1,3-propanediol)phosphite, bis(2,4-di-t-butylphenyl)pentaerythritol diphosphite or distearyl pentaerythritol diphosphite, as well as triphenyl phosphine, alkylated monophenols, polyphenols, alkylated reaction products of polyphenols with dienes, such as, e.g., butylated reaction products of para-cresol and dicyclopentadiene, alkylated hydroquinones, hydroxylated thiodiphenyl ethers, alkylidene-bisphenols, benzyl compounds, acylaminophenols, esters of beta-(3,5-di-tert-butyl-4-hydroxyphenol)-propionic acid with monohydric or polyhydric alcohols, esters of beta-(5-tert-butyl-4-hydroxy-3-methylphenyl)-propionic acid with monohydric or polyhydric alcohols, esters of beta-(5-tert-butyl-4-hydroxy-3-methylphenyl) propionic acid with mono-or polyhydric alcohols, esters of thioalkyl or thioaryl compounds, such as, e.g., distearylthiopropionate, dilaurylthiopropionate, ditridecylthiodipropionate, amides of beta-(3,5-di-tert-butyl-4-hydroxyphenol)-propionic acid.

Suitable UV absorbers and light stabilizers include 2-(2′-hydroxyphenyl)-benzotriazoles, 2-Hydroxy-benzophenones; esters of substituted and unsubstituted benzoic acids, acrylates, nickel compounds.

Suitable peroxide scavengers include (C₁₀-C₂₀)alkyl esters of betathiodipropionic acid, mercapto benzimidazole.

Suitable fillers and reinforcing agents include silicates, TiO₂, glass fibers, carbon black, graphite, calcium carbonate, talc, mica.

Suitable flame retardant additives include alkaline- and alkaline earth-salts, halogen-containing organic flame retardant compounds, organophosphate flame retardant compounds and borate flame retardant compounds. The flame retardant salts include perfluoroalkane sulfonate salts of alkali metal or alkaline earth metal and metal salts of organic sulfonic acids. Such salts are known and include have been disclosed in U.S. Pat. NOs. 3,535,300; 3,775,367; 3,909,490; and 3,917,559 which are incorporated herein by reference.

Suitable halogen-containing flame retardant compounds include bromine-containing organic flame retardant compounds including tetrabromooligocarbonate, terabromophthalimide, tribromophenoxymethane, bis(tribromophenoxy)ethane, tris(tribromophenyl)-triphosphate, hexabromocyclodecane, decabromodiphenylether or a brominated epoxy resin, including copolymers of tetrabromobisphenol A and epichlorohydrin.

Suitable organophosphate flame retardant compounds include, e.g., phenyl bisdodecyl phosphate, ethyl diphenyl phosphate, resorcinol diphosphate, diphenyl hydrogen phosphate, tritolyl phosphate, 2-ethylhexyl hydrogen phosphate, and bisphenol-A phosphate.

The thermoplastic resin composition may be formed into useful articles by a variety of means including injection, extrusion, rotation, blow molding and thermoforming.

### EXAMPLES

### Comparative Example (C-1)

The components—94.25% a homopolycarbonate based on bisphenol A (Bayer's Makrolon 2608 polycarbonate) in pellet form, 5% Makrolon 2608 polycarbonate in powder form, 0.25% carbon black powder, and 0.5% PTFE in powder form (DuPont Teflon K-10)—were tumble blended in a drum for fifteen minutes (the percents refer to percent by weight) and the resulting blend mixed in the melt in a twin-screw extruder (Werner Pfleider ZSK 30) stranded and diced following conventional procedures.

The melt flow rate of the resulting pellets (dried for 4 hours at 250° F. under vacuum) was determined, and test specimens were molded by injection molding (Robshot Cincinnati molding machine: shot capacity of 3.4 ounces; Set temperatures: 535° F. nozzle, 540° F. front, 535° F. middle, and 530° F. rear. Mold temperature was 170° F., cycle time=30 seconds)

Compositions (designated I-1; I-2 and I-3), the properties of which are shown below, were prepared and tested. Test specimens were molded of each and tested.
I-1: As in the case of C1 was prepared by introducing 0.84% PTFE water dispersion (Dyneon PA 5959) that contained 58.2% PTFE and about 5.2% wetting agent (the percents refer to percent by weight) into stationary polycarbonate (93.91% Makrolon 2608 PC in pellet form, 5% Makrolon 2608 PC in powder form, 0.25% carbon black powder) in a drum and then tumble blending for fifteen minutes. The resulting blend was dried at room temperature and melt blended in a twin-screw extruder (Werner Pfleider ZSK 30) stranded and diced following conventional procedures.
I-2: To stationary polycarbonate (86.15% Makrolon 2608 PC in pellet form, 5% Makrolon 2608 in powder form, 0.25% carbon black powder and 8.6%) there was introduced PTFE master batch and the resulting material system then tumble blended for 15 minutes and the resulting blend dried at room temperature and then melt blended in a twin-screw extruder (Wemer Pfleider ZSK 30) stranded and diced following conventional procedures. The master batch was similarly prepared except that the respective components were 20% Makrolon 2608 PC in pellet form, 66% Makrolon 2608 PC in powder form, 4% fumed silica and 10% PTFE water dispersion. The tumble blending was for 10 minutes.
I-3: To stationary polycarbonate (90% Makrolon 2608 PC in pellet form, 5% of Makrolon 2608 PC in powder form) there was introduced 5% of a PTFE master batch and the material system thus obtained was tumble blended for 15 minutes. The resulting blend was then dried as described above and the dried mixture then melt blended in a twin-screw extruder (Werner Pfleider ZSK 30) stranded and diced following conventional procedures. The master batch was prepared as in 1-3 except that tumble blending lasted 10 minutes and the relative amounts of the components were: 10% Makrolon 2608 PC in pellet form, 75% Makrolon 2608 PC in powder form, and 15% PTFE water dispersion.

The test results are shown in Table 1 below:

TABLE 1

| | C-1 | I-1 | I-2 | I-3 |
|---|---|---|---|---|
| PTFE¹ (%) | 0.45 | 0.43 | 0.44 | 0.49 |
| MFR² | 9.2 | 8 | 9 | 10.7 |
| Impact Strength | 6.1 | 17.2 | 18.2 | 12.8 |
| Flammability Rating UL94- | F* | VO | VO | VO |
| 5VA at 1/16″ VO | | | | |
| UL94-5VA at ⅛″ | F | P** | P | P |
| Molded Part Appearance*** | Poor | Good | Good | Good |

¹PTFE content of the composition.
²Melt flow rate (g/10 min.) determined in accordance with ASTM D-1238 (300° C./1.2 Kg loading).
³notched Izod impact strength (ft-lb/in) determined per ASTM D 256 at ⅛″ thickness.
*F denotes failed
**P denotes passed
***by visual observation, “poor” denotes considerable splay and “good” denotes a surface that is virtually free of surface defects (splay, silver streaking, pitting).

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A process for making a thermoplastic composition comprising
(i) introducing an aqueous dispersion of PTFE into stationary aromatic polycarbonate resin in the form of powder and/or pellets to obtain a material system and then
(ii) blending the material system optionally with additional polycarbonate to obtain a mixture,
(iii) drying the mixture to obtain a dried mixture having water content of less than 2 percent relative to its weight, and
(iv) melt blending the dried mixture , optionally with additional polycarbonate to obtain a thermoplastic composition.

2. The process of claim 1 wherein the thermoplastic composition said contains PTFE in an amount sufficient to impart to the composition flame-retardance rating of UL94-V0 at 1/16″ and impact strength (notched Izod) of at least 10 ft-lb/in at ⅛″, the UL ratings attained without the incorporation of additional flame retardant agent therewith.

3. The process of claim 1 wherein the dispersion is introduced in an amount of 0.2 to 25 percent relative to the weight of the material system.

4. The process of claim 1 wherein the dispersion is introduced in an amount of 0.30 to 15 percent relative to the weight of the material system.

5. The process of claim 1 wherein the amount of PTFE is 0.2 to 1.0 percent relative to the weight of the composition.

6. The process of claim 1 wherein the aqueous dispersion contain 0.5 to 6% of alkylphenolethoxylate and a positive amount that is less than 0.5% of ammonium perfluorooctanoate, said percents being relative to the weight of the dispersion.

7. The composition made by the process of claim 1.

8. The composition made by the process of claim 2.

9. The composition made by the process of claim 3.

10. The composition made by the process of claim 4.

11. The composition made by the process of claim 5.

12. The composition made by the process of claim 6.
